(19) United States
(12) Patent Application Publication
(10) Pub. No.: US 2004/0169415 A1
(43) Pub. Date: Sep. 2, 2004

(54) Hub bearing unit with a separate axle stub

(76) Inventors: Hendrikus Jan Kapaan, Niewegein (NL); Rico Dittmar, Schmalkalden (DE); Sven Gothberg, Frolunda (SE); Jesko-Henning Tanke, Schweinfurt (DE); Norbert Huhn, Schweinfurt (DE)

Correspondence Address: Young & Thompson, Second Floor, 745 South 23rd Street, Arlington, VA, 22202, US

(21) Appl. No.: 10/480,483

(22) PCT Filed: Jun. 14, 2002
(86) PCT No.: PCT/NL02/00393

(30) Foreign Application Priority Data
Jun. 15, 2001 (NL) 1018300

(51) Int. Cl. B60B 27/00

(52) U.S. Cl. 301/105.1

(57) ABSTRACT

A hub bearing unit comprises an axle stub (41) and a coaxial hub member which is rotatably supported with respect to the axle stub by two rolling element bearings (34). The axle stub is provided with connection elements for detachably connecting the axle stub to a vehicle axle. The axle stub (1) may have a screw-threaded end for connection to a correspondingly screw-threaded bore of the vehicle axle, as well as a tapered end for connection to a correspondingly tapered bore of the vehicle axle.

The invention is related to a hub bearing unit comprising an axle stub and a coaxial hub member which is rotatably supported with respect to the axle stub by means of two rolling elements bearings.

Such a hub bearing unit is known from EP-A-909663, and can in particular be applied in trucks. The object of the invention is to provide a hub bearing unit of this kind which can be preassembled, and which can subsequently be mounted as a unity onto the vehicle axle.

This object is achieved in that the axle stub is provided with rotational symmetric connection means for detachably connecting the axle stub to a vehicle axle. The connection means in question can be carried out in several ways. According to a first possibility, the axle stub can have a screw-threaded end for connection in a correspondingly screw-threaded bore of the vehicle axle. In that case, the unit can be mounted by screwing the axle stub onto the vehicle axle. The other end of the axle stub may have e.g. a hexagon on its outer end. Advantageously, the unit can also be dismounted as a unity. Therefore, it is not necessary to dismount the various parts of the unit separately.

Alternatively, the axle stub may have a cylindrical or tapered end for connection to a correspondingly cylindrical or tapered bore of the vehicle axle. E.g. the said tapered end may be integrally formed with the axle stub; in the alternative, the tapered end may be formed by a separate tapered sleeve positioned on a cylindrical end of the axle stub. Said tapered sleeve can be fixed in rotational direction by means of a key/groove connection, and axially by means of a circlip. Furthermore, the screw threaded end may be integrated with the tapered sleeve. The axle stub may also have a cylindrical end.

According to another possible embodiment, the axle stub can have a through-going bore which at its end facing away from the connection end opens out in a support face, said bore being for accommodation a fixing rod which has a head on its outer end and fixing means on its inner end, which head can engage the support face. At its end facing the vehicle axle, the axle stub can have an abutment face which can engage a corresponding face on the vehicle axle. Moreover, the fixing rod may have a screw-threaded end which can engage a correspondingly screw-threaded bore of the vehicle axle.

At least one of the bearings may have a raceway which can be integrated in the axle stub. Also, one of the bearings may have an inner bearing ring which is fitted on the axle stub. A combination of an integrated raceway and a ring is also possible.

The axle stub may have a flange at its end facing away from the connection end, said flange being bent over so as to exert an axial preload on the adjoining inner ring. According to another embodiment, the axle stub may have a fixing nut at its end facing away from the connection end, said nut exerting an axial preload on the adjoining inner ring.

Furthermore, the rolling element bearings may have a common outer ring. Such common outer bearing ring may be provided with a mounting flange. Alternatively, said common outer bearing ring can be accommodated in a hub member which is provided with a wheel mounting flange, and/or a brake disc.

The invention will be described further with reference to the drawings.

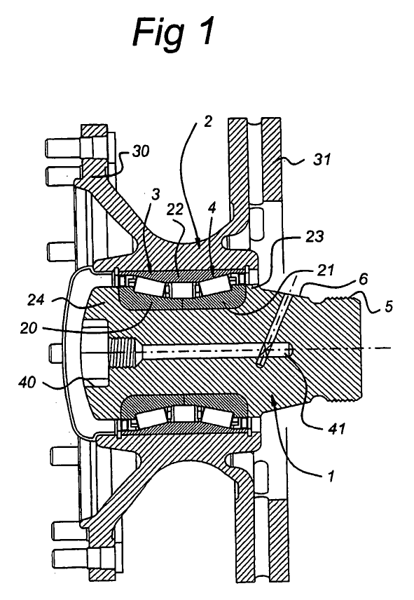

FIG. 1-7 show several embodiments of a hub bearing unit according to the invention.

The hub bearing units according to FIG. 1-5 are each provided with an axle stub 1. A coaxial hub member 2 is rotatedly supported on the axle stub I by means of the two taper roller bearings 3, 4. According to the invention the axle stub 1 according to these embodiments are all provided with connection means, which will be described now.

In the embodiment of FIG. 1, the axle stub 1 has a screw-threaded end 5 for connection in a correspondingly screw-threaded bore of a vehicle axle (not shown). Furthermore, said axle stub 1 has a tapered end 6 joining the screw-threaded end 5. Said tapered end 6 is intended to be connected in a correspondingly tapered bore of the vehicle axle (not shown). An oil injection channel 41 is provided for the purpose of facilitating the removal of the tapered end 6 from its bore.

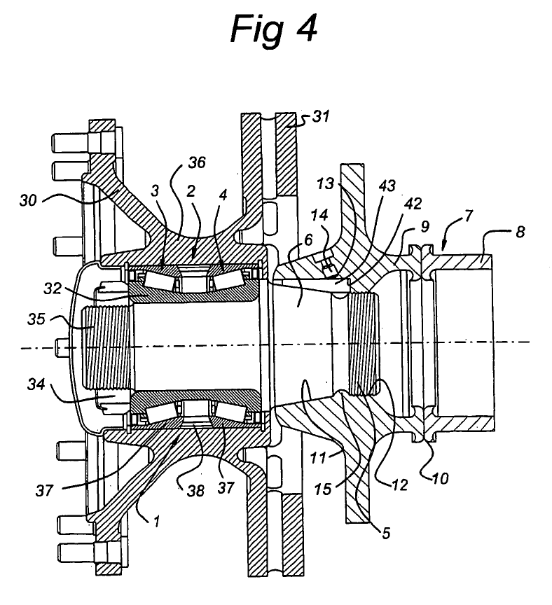

A similar layout is shown in FIG. 4, in combination with the vehicle axle 7. This vehicle axle 7 consists of the vehicle axle tube 8 and a connection ring 9 which are connected to each other by means of the friction weld 10. In the embodiment shown in the lower part of FIG. 4, the connection ring 9 has a tapered bore 11 as well as a screw-threaded bore 12, which engage respectively the tapered end 6 and the screw-threaded end 5 of the axle stub 1. Furthermore, the connection ring 9 comprises a screw-threaded bore 14, into which a locking screw can be provided which engages the axle stub 1 at the spot of its circumferential groove 15.

In the embodiment shown in the upper part of FIG. 4, the connection ring 9 has a cylindrical bore 42 provided with a tapered sleeve 43. The tapered end 6 of the axle stub 1 is accommodated in said tapered sleeve 43. Its screw threaded end 5 is screwed in the screw threaded bore 14 of connection ring 9.

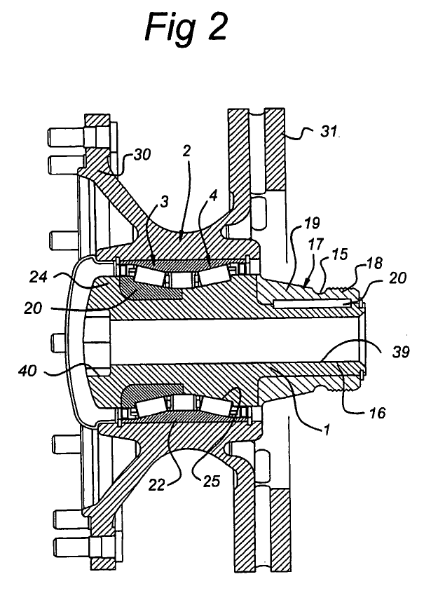

In the embodiment of FIG. 2, the axle stub I has a cylindrical end 16 onto which the sleeve 17 is mounted. Said sleeve comprises a screw-threaded end 18 and a tapered end 19, separated by a circumferential groove 15. Through the key/groove connection 20, the sleeve is fixed in a rotational direction with respect to the axle stub 1.

The axle stub has a throughgoing bore 39 which can be used for accommodating a wheel drive shaft (not shown). Moreover, as in the embodiment of FIG. 1, a hexagon 40 has been provided for applying a torque.

In the embodiment of FIG. 1, the two tapered roller bearings have each a separate inner ring 20, 21, as well as a common outer ring 22 which carry the raceways. The inner rings 20, 21 are accommodated between the flanges 23, 24. The latter flange 24 is bent over so as to provide the desired preload in the bearings 3, 4.

In the embodiment of FIG. 2, a single separate inner ring 20 has been provided for the bearing 3, whereas the bearing 4 engages a raceway 25 which is integrated in the axle stub 1. The bearings 3, 4 again engage a common outer ring.

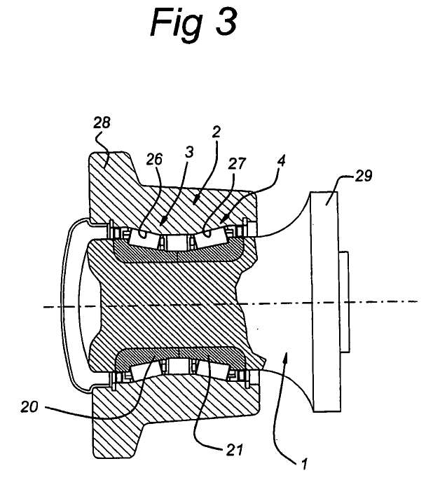

The embodiment of FIG. 3, the coaxial hub member 2 has been provided with integrated raceways 26, 27 Moreover, the coaxial hub member 2 has been provided with a mounting flange 28. Stub axle 1 comprise a connection flange 29, by means of which the hub bearing unit can be connected to a vehicle axle (not shown).

The embodiments of FIGS. 1, 2 and 3 each have a flange 30 on to which a wheel can be mounted. Furthermore, the coaxial hub number 2 carries a brake disc 31. In the embodiment of FIG. 4, the taper roller bearings 3, 4 comprise a common inner ring 32, which is fixed by means of the nut 34 which is screwed onto the screw-threaded end 35 of the axle stub 1. The bearings 3, 4 have separate outer rings 36, 37 which are held spaced apart by means of the distance ring 38.

The connection ring 9 contains the fixation means for the brake calliper. These fixation means can also form one piece with the tapered or cylindrical end 6 which fits in the connection ring 9.

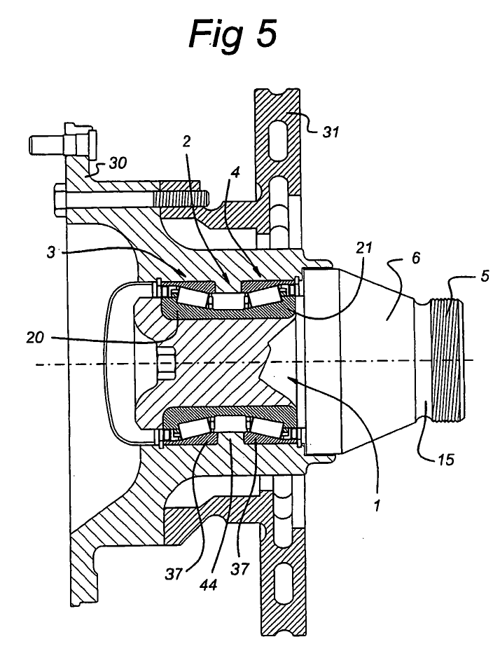

The embodiment of FIG. 5 comprises bearings 3, 4, the outer rings 36, 37 of which are in abutting relationship with an internal shoulder 44 of the hub member 2 (matched bearings).

The tapered or cylindrical end of the axle stub in the embodiments described before may have a coating to avoid fretting corrosion.

Furthermore, it is possible to fix the axle stub by means of a bolt extending through a central bore thereof.

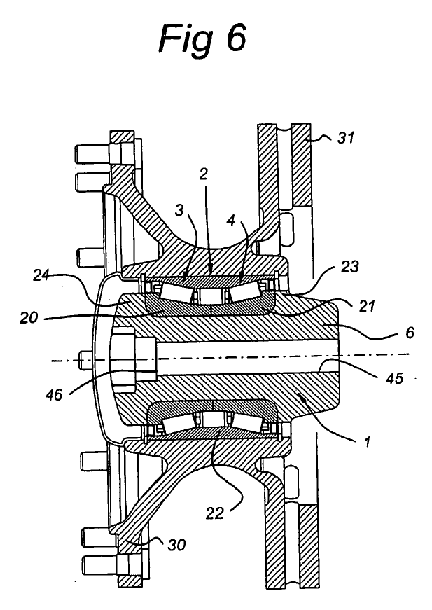

FIG. 6 shows an embodiment which largely corresponds to the embodiment of FIG. 1. However, the axle stub 1 now has only a tapered end 6 for connecting. A bore 45 extends through the axle stub 1 for accommodating a connection screw (not shown), the head of which bears on land 46. By means of said screw and tapered end 6, the hub bearing unit in question may be mounted onto a vehicle axle.

The embodiment of FIG. 7 comprises a cylindrical end 47, which is accommodated in a correspondingly cylindrical opening in the vehicle axle 48. By means of a screw 49 which is accommodated in a correspondingly screw threaded bore 50 of the vehicle axle 48 the complete unit is detachably connected to the vehicle axle.

1. Hub bearing unit, comprising an axle stub (1) and a coaxial hub member (2) which is rotatably supported with respect to the axle stub (1) by means two rolling element bearings (3, 4), characterized in that the axle stub (1) is provided with rotational symmetric connection means (5, 6; 17; 29) for detachably connecting the axle stub (1) to a vehicle suspension axle (7).

2. Unit according to claim 1, wherein the axle stub (1) has a screw-threaded end (5; 18) for connection to a correspondingly screw-threaded bore (12) of the vehicle axle (7).

3. according to claim 1 or 2, wherein the axle stub (1) has a tapered end (6; 19) for connection to a correspondingly tapered bore (11) of the vehicle axle (7).

4. Unit according to claim 3, wherein the tapered end (6) is integrally formed with the axle stub (1).

5. Unit according to claim 3, wherein the tapered end (19) is formed by a separate tapered sleeve (17) positioned on a cylindrical end (16) of the axle stub (1).

6. Unit according to claim 5, wherein the tapered sleeve (17) is fixed in rotational direction by means of a key/groove connection (20).

7. Unit according to claim 2 and 5, wherein the screw threaded end (18) is integrated with the tapered sleeve (17).

8. Unit according to any of the preceding claims, wherein the axle stub (1) is solid.

9. Unit according to any of the preceding claims, wherein the axle stub (1) has a through-going bore (39) which at its end facing away from the connection end opens out in a support face, said bore (39) being for accommodating a wheel drive shaft

10. Unit according to claim 9, wherein the axle stub at its end facing the vehicle axle has an abutment face which can engage a corresponding face on the vehicle axle.

11. Unit according to claim 9 or 10, wherein the fixing rod has a screw-threaded end which can engage a correspondingly screw-threaded bore of the vehicle axle.

12. Unit according to any of the preceding claims, wherein at least one of the bearings (4) has a raceway (25) which is integrated in the axle stub (1).

13. Unit according to any of the preceding claims, wherein at least one of the bearings (3, 4) has an inner bearing ring (20, 21;32) which is fitted on the axle stub (1).

14. Unit according to any of the preceding claims, wherein setting means (34) are provided for setting a predetermined preload or play in the bearings (3, 4).

15. Unit according to claim 14, wherein the axle stub (1) has a flange (24) at its end facing away from the connection end, said flange (24) being bent over so as to exert an axial preload on the adjoining inner ring (20).

16. Unit according to claim 14, wherein the axle stub (1) has a fixing nut (34) at its end facing away from the connection end, said nut (34) exerting an axial preload on the adjoining inner ring (32).

17. Unit according to any of the preceding claims, wherein the rolling element bearings (3, 4) have a common outer ring (22).

18. Unit according to claim 17, wherein the common outer bearing ring is provided with a mounting flange (28).

19. Unit according to any of the preceding claims, wherein the rolling element bearings are tapered roller bearings (3, 4).

20. Unit according to any of claims 1-18, wherein the rolling element bearings are ball bearings.

21. Unit according to any of the preceding claims, wherein a combination of a tapered rolling element bearing and a ball bearing is provided.

22. Unit according to claim 17, wherein the common outer bearing ring is accommodated in axial hub member which is provided with a wheel mounting flange (30), and/or a brake disc (31).

23. Unit according to any of the preceding claims, wherein the axle stub comprises two axle stub parts which are permanently connected to each other, e.g. by energy welding or friction welding.

24. Unit according to any of the preceding claims, wherein at least a sensor is provided for measuring rotating speed, temperate and/or load etc.

25. Unit according to any of the preceding claims, wherein the axle stub contains at least one passage for a liquid, gas or cables.

26. Unit according to claims 1 or 2, wherein the axle stub has a cylindrical end for connection to a correspondingly cylindrical bore of the vehicle axle.

27. Unit according to claims 1 or 2, wherein the axle stub has a bore and the vehicle axle has a correspondingly shaped end for connection to said bore.
